(19) United States
(12) Patent Application Publication
(10) Pub. No.: US 2023/0084890 A1
(43) Pub. Date: Mar. 16, 2023

(54) VEHICLE, UNLOCKING APPARATUS, AND METHOD

(71) Applicant: NEC Corporation, Minato-ku, Tokyo (JP)

(72) Inventor: Aki HATAKEYAMA, Tokyo (JP)

(73) Assignee: NEC Corporation, Minato-ku, Tokyo (JP)

(21) Appl. No.: 17/801,321

(22) PCT Filed: Mar. 9, 2020
(86) PCT No.: PCT/JP2020/010011

§ 371 Date: Aug. 22, 2022

(51) Int. Cl. B60R 25/25; E05B 49/00; E05F 15/73

(52) U.S. Cl. CPC B60R 25/25; E05B 49/00; E05F 15/73

(57) ABSTRACT

A registrant detection means detects, by checking a captured image captured by an imaging apparatus mounted on a vehicle against face images of registrants, that the registrant has approached the vehicle, and detects a position of the registrant. A control target determination means determines which of a plurality of doors of the vehicle is to be controlled based on the position of the registrant. An inquiry means asks the registrant whether or not to unlock a door lock. A door control means unlocks a lock of the door determined to be the control target based on a result of the inquiry.

### TECHNICAL FIELD

The present disclosure relates to a vehicle, an unlocking apparatus, a method, and a computer readable media.

### BACKGROUND ART

As a related technique, Patent Literature 1 discloses a vehicle system that enables a user to easily get in a vehicle. The vehicle described in Patent Literature 1 acquires a face image of a user, and checks the acquired face image against images of registered users. The vehicle unlocks a door lock if it is determined that the user is one of the registered users as a result of the check. In Patent Literature 1, the vehicle can not only unlock the door lock but also open the door automatically. The vehicle can also unlock the trunk and automatically open the trunk when the user performs a predetermined action such as winking.

As another related technique, Patent Literature 2 discloses an authentication apparatus for an apparatus mounted on a vehicle. The authentication apparatus described in Patent Literature 2 stores face images of usage authority holders and usage authority information in association with each other. The authentication apparatus acquires a face image (checking image) of a user by using a camera, and checks the acquired face image against the registered face images. When the checked image matches one of the registered face image, the authentication apparatus permits the use of the apparatus mounted on the vehicle based on the usage authority information stored in association with the face image. The authentication apparatus operates a door locking apparatus and unlocks or locks the door of the vehicle when the usage authority information includes a permission to use the door locking apparatus.

### CITATION LIST

### Patent Literature

Patent Literature 1: International Patent Publication No. WO 2017/163488

Patent Literature 2: Japanese Unexamined Patent Application Publication No. 2017-223068

### SUMMARY OF INVENTION

### Technical Problem

In Patent Literature 1 and 2, the door lock can be unlocked or the door can be automatically opened by using face authentication. However, in Patent Literature 1 and 2, all locks of the vehicle are unlocked. In Patent Literature 1 and 2, the door locks of the driver's seat and the passenger's seat are also unlocked even when a user wants to unlock the door lock of the rear seat, for example, in order to seat a child in a car seat. Thus, in the related techniques, it is not possible to unlock a necessary door when necessary, and there is a problem that hospitality is low.

In view of the above circumstances, an object of the present disclosure is to provide a vehicle, an unlocking apparatus, a method, and a computer readable medium capable of enhancing hospitality.

### Solution to Problem

In order to achieve the above object, the present disclosure provides an unlocking apparatus including: registrant detection means for detecting, by checking a captured image captured by an imaging apparatus mounted on a vehicle against face images of registrants, that the registrant has approached to the vehicle, and detecting a position of the registrant; control target determination means for determining which of a plurality of doors of the vehicle is to be controlled based on the position of the registrant; inquiry means for asking the registrant whether or not to unlock a door lock; and door control means for unlocking a lock of the door determined to be the control target based on a result of the inquiry.

The present disclosure further provides a vehicle including: an imaging apparatus configured to capture a periphery of the vehicle; and an unlocking apparatus configured to unlock a door. The unlocking apparatus includes: registrant detection means for detecting, by checking a captured image captured by an imaging apparatus mounted on a vehicle against face images of registrants, that the registrant has approached to the vehicle, and detecting a position of the registrant; control target determination means for determining which of a plurality of doors of the vehicle is to be controlled based on the position of the registrant; inquiry means for asking the registrant whether or not to unlock a door lock; and door control means for unlocking a lock of the door determined to be the control target based on a result of the inquiry.

The present disclosure further provides an unlocking method including: detecting, by checking a captured image captured by an imaging apparatus mounted on a vehicle against face images of registrants, that the registrant has approached to the vehicle, and detecting a position of the registrant; determining which of a plurality of doors of the vehicle is to be controlled based on the position of the registrant; asking the registrant whether or not to unlock a door lock; and unlocking a lock of the door determined to be the control target based on a result of the inquiry.

The present disclosure further provides a non-transitory computer readable medium storing a program for causing a processor to execute processing of: detecting, by checking a captured image captured by an imaging apparatus mounted on a vehicle against face images of registrants, that the registrant has approached the vehicle, and detecting a position of the registrant; determining which of a plurality of doors of the vehicle is to be controlled based on the position of the registrant; asking the registrant whether or not to unlock a door lock; and unlocking a lock of the door determined to be the control target based on a result of the inquiry.

### Advantageous Effects of Invention

A vehicle, an unlocking apparatus, a method, and a computer readable medium according to the present disclosure can enhance hospitality.

### BRIEF DESCRIPTION OF DRAWINGS

FIG. 1 is a block diagram showing an overview of an unlocking apparatus according to the present disclosure;

FIG. 2 is a block diagram showing a vehicle including an unlocking apparatus according to an example embodiment of the present disclosure;

FIG. 3 is a flowchart showing an operation procedure of the unlocking apparatus; and

FIG. 4 is a block diagram showing a hardware configuration of an electronic control apparatus.

### EXAMPLE EMBODIMENT

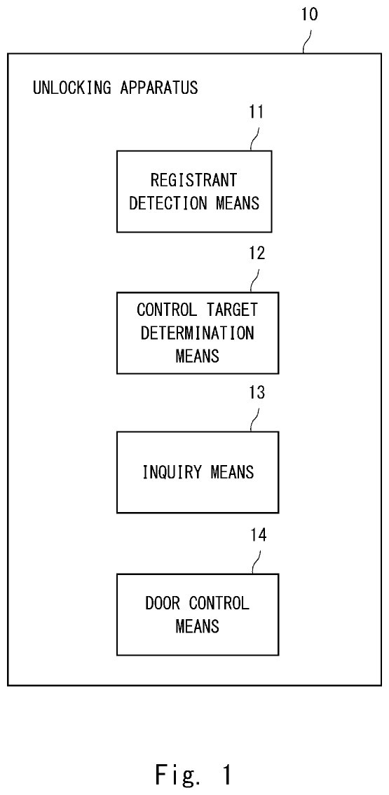

Prior to the description of an example embodiment of the present disclosure, an overview of the present disclosure will be described. FIG. 1 shows an overview of an unlocking apparatus according to the present disclosure. An unlocking apparatus 10 includes registrant detection means 11, control target determination means 12, inquiry means 13, and door control means 14.

The registrant detection means 11 checks a captured image captured by an imaging apparatus mounted on a vehicle against face images of registrants, and detects that the registrant has approached the vehicle. The registrant detection means 11 detect which part of the vehicle the registrant has approached.

The control target determination means 12 determines which door among a plurality of doors of the vehicle is to be controlled (i.e., the door to be controlled shall be hereinafter referred to as a control target) based on the position of the registrant. The inquiry means 13 asks the registrant who has approached the vehicle whether or not a door lock is unlocked. The door control means 14 controls the lock of the door determined to be a control target based on a result of the inquiry.

In the present disclosure, the control target determination means 12 determines a door to be controlled according to the position of the registrant. For example, when the registrant approaches a rear seat door, the control target determination means 12 determines the door approached by the registrant as a control target door. The door control means 14 unlocks the lock of the control target door when the registrant instructs unlocking of the door in response to the inquiry. The present disclosure can enhance the hospitality for a user, because the door is unlocked according to the position of the registrant.

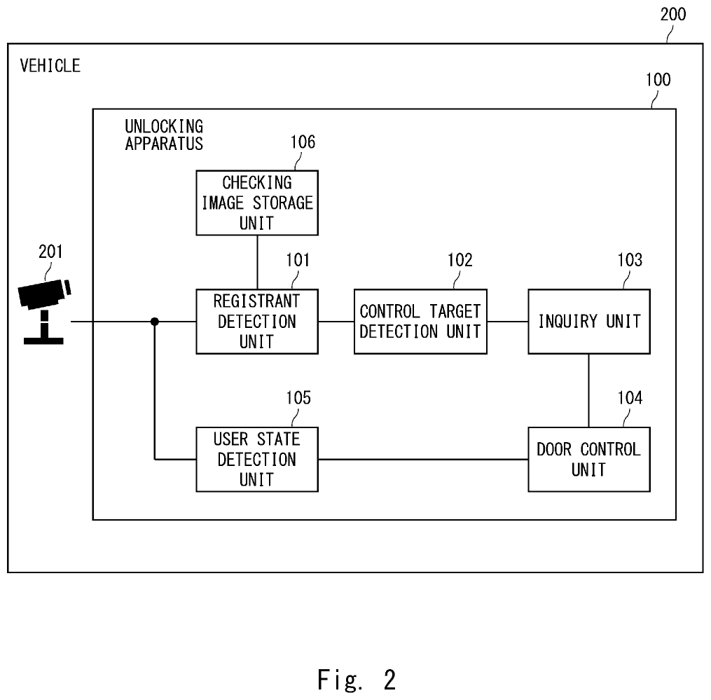

An example embodiment of the present disclosure will now be described in detail with reference to the drawings. FIG. 2 shows a vehicle including an unlocking apparatus according to the example embodiment of the present disclosure. A vehicle 200 includes an unlocking apparatus 100 and an imaging apparatus 201. The imaging apparatus 201 captures the periphery of a vehicle. Although only one imaging apparatus 201 is shown in FIG. 2, the vehicle 200 may include a plurality of imaging apparatuses 201. The vehicle 200 may include, for example, an imaging apparatus disposed on an upper part of a windshield to capture an area in front of the vehicle, and an imaging apparatus installed on a rear part of the vehicle to capture an area behind the vehicle. The vehicle 200 may further include imaging apparatuses disposed in the vicinity of the left and right doors of the front seats and captures areas on the lateral side of the vehicle.

A checking image storage unit 106 stores face image data of a driving target person (registrant). The checking image storage unit 106 stores face image data of a plurality of driving target persons when a plurality of driving target persons are present. The registrant detection unit 101 acquires a captured image from the imaging apparatus 201. When the captured image includes the person's face approaching the vehicle, the registrant detection unit 101 checks image data of a face area against the face image data stored in the checking image storage unit 106. The checking image storage unit 106 may store features extracted from face image data of the driving target person. In this case, the registrant detection unit 101 may check features extracted from the face area included in the captured image against the features stored in the checking image storage unit 106. Any algorithm used in face authentication can be used for the checking.

The registrant detection unit 101 determines whether or not the person approaching the vehicle is a driving target person (a registrant) based on the result of the checking. The registrant detection unit 101 tracks the movement of the registrant when the driving target person approaches within a predetermined distance (a first threshold value) from the vehicle, for example, to within two meters from the vehicle. When the driving target person approaches to within a predetermined distance (a second threshold value) from the vehicle, for example, to a distance of 0.5 m from the vehicle, the registrant detection unit 101 detects a part of the vehicle the driving target person approaches. When the driver approaches the vehicle, the registrant detection unit 101 notifies the control target determination unit 102 of the position of the driving target person. The registrant detection unit 101 corresponds to the registrant detection means 11 shown in FIG. 1.

The control target determination unit 102 determines which door among a plurality of doors of the vehicle 200 is to be a control target based on the position of the driving target person. Here, the vehicle door shall, for convenience, include a rear hatch gate and a trunk lid. For example, when the driving target person approaches the door on the driver's seat side, the control target determination unit 102 determines the door on the driver's seat side as a control target. The control target determination unit 102 determines a left rear door to be a control target when the driving target person approaches the left rear door. The control target determination unit 102 corresponds to the control target determination means 12 shown in FIG. 1.

The inquiry unit 103 asks the driving target person whether or not the door lock is unlocked. The inquiry unit 103 outputs an announcement such as “Do you want to unlock the door?” to the driving target person by a voice using, for example, a vehicle exterior speaker. The inquiry unit 103 acquires a response to the inquiry of the driving target person after the output of the announcement. The inquiry unit 103 may acquire the driving target person's voice through, for example, a microphone and perform voice recognition to thereby acquire a response.

Alternatively, the inquiry unit 103 may obtain a response by using a captured image of the driving target person captured by using the imaging apparatus 201. The inquiry unit 103 may, for example, detect a movement of the driving target person's lips and acquire the response of the driving target person. Further alternatively, the inquiry unit 103 may acquire a response according to whether or not the driving target person has made a predetermined movement. The inquiry unit 103 may determine the response (an instruction) of the driving target person based on the movement of, for example, the driving target person's head. For example, the inquiry unit 103 may determine that the driving target person has instructed unlocking of a door lock when the driving target person moves his or her head up, down, left, right, vertical, horizontal, or circular. The inquiry unit 103 corresponds to the inquiry means 13 shown in FIG. 1.

The user state detection unit (user state detection means) 105 detects a state of the driving target person based on the captured image of the imaging apparatus 201. The user state detection unit 105 determines, for example, based on image data of a hand part in the captured image, whether the driving target person has his or her hands full holding luggage, that is, whether the driving target person holds luggage with both of his or her hands. The user state detection unit 105 notifies the door control unit 104 of the detected state of the driving target person. If the driving target person has his or her hands full, the user state detection unit 105 notifies the door control unit 104 of the fact. If the driving target person does not have his or her hands full, the user state detection unit 105 notifies the door control unit 104 of the fact. If it is unclear whether or not the driving target person has his or her hands full, the user state detection unit 105 notifies the door control unit 104 of the fact.

The door control unit 104 controls the lock of the door determined to be the control target based on the response (an inquiry result) of the driving target person to the inquiry of the inquiry unit 103. The door control unit 104 unlocks the door determined to be the control target when, for example, the driving target person performs a predetermined action after the announcement. The door control unit 104 corresponds to the door control means 14 of FIG. 1.

The inquiry unit 103 may ask the driving target person whether or not to open the door after the door lock is unlocked. The door control unit 104 opens the control target door if the driving target person wishes to open the door. Alternatively, the door control unit 104 may open the control target door according to the state of the driving target person detected by the user state detection unit 105. The door control unit 104 may automatically open the door after unlocking it, for example, if the driving target person has his or her hands full or if it is unknown whether or not the driving target person has his or her hands full.

The door control unit 104 may acquire the captured image from the imaging apparatus 201, check whether an obstacle is present around the control target door, and determine whether there is a space to open the control target door. The door control unit 104 does not open the door if it is determined that there is no space for opening the door, because an obstacle is present around the control target door. The door control unit 104 opens the control target door if it is determined that there is a space for opening the door.

After the control target door is unlocked, the inquiry unit 103 may determine whether a person other than the driving target person is approaching the vehicle. Whether or not a person other than the driving target person is approaching the vehicle can be determined, for example, by using a captured video of the imaging apparatus 201. The inquiry unit 103 may ask the driving target person whether or not to unlock the door when a person is present in the vicinity of the door different from the unlocked door. The door control unit 104 unlocks another door when the unlocking of the other door is instructed.

The door control unit 104 may determine whether or not the driving target person has entered the vehicle after the door is unlocked. It may be determined whether or not the driving target person has entered the vehicle, for example, based on the image captured by the imaging apparatus installed inside the vehicle. The door control unit 104 may lock the control target door when the driving target person enters the vehicle. The door control unit 104 may lock the control target door when the driving target person moves away from the vehicle 200 by a predetermined distance or more, for example, 2 meters or more after the door is unlocked.

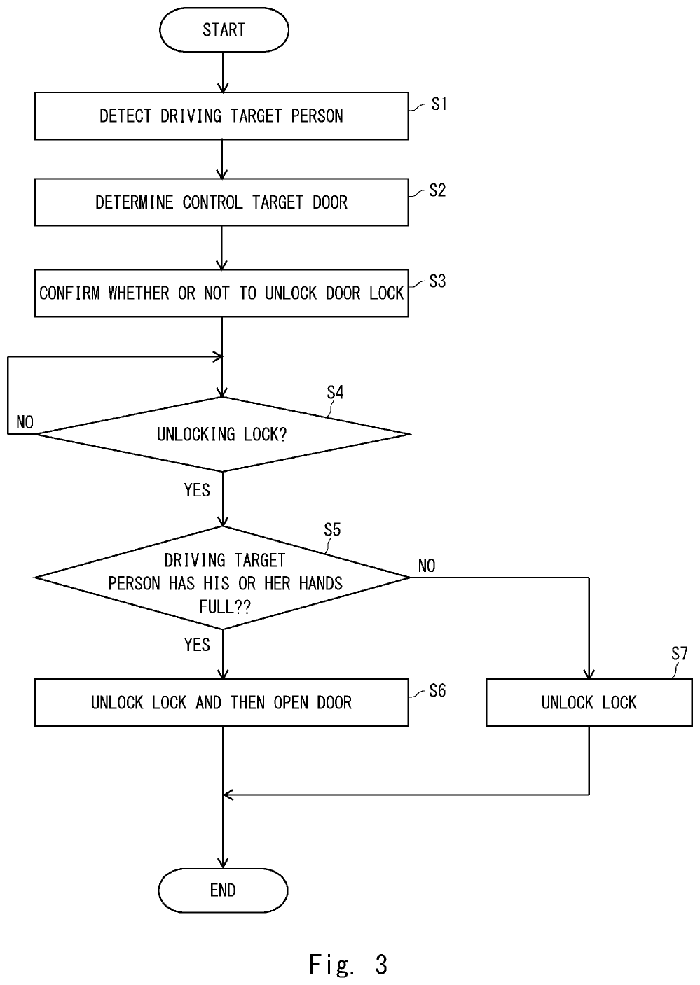

Next, an operation procedure will be described. FIG. 3 shows an operation procedure (an unlocking method) of the unlocking apparatus. The registrant detection unit 101 detects the driving target person approaching the vehicle 200 (Step S1). The control target determination unit 102 determines a control target door according to a position of the driving target person (Step S2). The inquiry unit 103 asks the driving target person whether or not to unlock a door lock (Step S3).

In response to the inquiry, the inquiry unit 103 determines whether or not the driving target person has instructed unlocking or a door lock (Step S4). For example, if the driving target person instructs unlocking of the door lock by a voice or by a predetermined action, the inquiry unit 103 notifies the door control unit 104 of the instruction. If the driving target person does not respond to the inquiry, the inquiry unit 103 waits until a response is obtained. If the driving target person moves away from the vehicle while the inquiry unit is waiting, the processing ends.

The user state detection unit 105 detects the state of the driving target person. When the driving target person instructs unlocking of a door lock, the door control unit 104 determines whether the driving target person has his or her hands full (Step S5). When the driving target person has his or her hands full, the door control unit 104 unlocks the control target door and then opens the door (Step S6). When the driving target person does not have his or her hands full, the door control unit 104 unlocks the control target door (Step S7).

In this example embodiment, the control target determination unit 102 determines the control target door according to the position of the registrant. The door control unit 104 unlocks the control target door when the registrant instructs unlocking of the control target door in response to the inquiry. In this example embodiment, since the door is unlocked according to the position of the registrant, the hospitality can be enhanced for the user. Further, in this example embodiment, when the driving target person holds the luggage with both of his or her hands, the door control unit 104 automatically opens the door as well as unlocks the door lock. In this manner, the user's convenience can be enhanced.

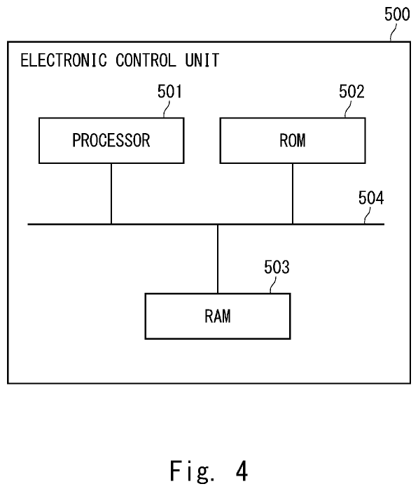

In the present disclosure, the unlocking apparatus 100 may be configured as electronic control units. FIG. 4 shows a hardware configuration of an electronic control apparatus that can be used for the unlocking apparatus 100 or the like. An electronic control unit 500 includes a processor 501, a ROM (read only memory) 502, and a RAM (random access memory) 503. In the electronic control unit 500, the processor 501, the ROM (read only memory) 502, and the RAM (random access memory) 503 are connected to each other via a bus 504. The electronic control unit 500 may include other circuitry, such as peripheral circuitry, communication circuitry, and interface circuitry, which are not shown.

The ROM 502 is a non-volatile storage device. The ROM 502 is a semiconductor memory device such as a flash memory having a relatively small capacity. The ROM 502 stores a program executed by the processor 501.

The above program can be stored and provided to the electronic control unit 500 using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), optical disk medium such as CD (compact disc) and DVD (digital versatile disk), and semiconductor memories (such as mask ROM, PROM (programmable ROM), EPROM (erasable PROM), flash ROM, RAM, etc.). The program may be provided to the electronic control unit using any type of transitory computer readable media. Examples of transitory computer readable media include electric signals, optical signals, and electromagnetic waves. Transitory computer readable media can provide the program to the electronic control unit via a wired communication line (e.g. electric wires, and optical fibers) or a wireless communication line.

The RAM 503 is a volatile storage device. Various semiconductor memory devices such as a DRAM (Dynamic Random Access Memory) or an SRAM (Static Random Access Memory) are used as the RAM 503. The RAM 540 may be used as an internal buffer for temporarily storing data and the like.

The processor 501 expands the program stored in the ROM 502 into the RAM 503 and executes it. The functions of each unit of the unlocking apparatus 100 can be implemented by the CPU 501 executing the program.

Although the example embodiments of the present disclosure have been described above in detail, the present disclosure is not limited to the above-described example embodiments, and changes or modifications to the above-described example embodiments are also included in the present disclosure to the extent that they do not depart from the spirit of the present disclosure.

The whole or part of the example embodiments disclosed above can be described as, but not limited to, the following supplementary notes.

### [Supplementary Note 1]

An unlocking apparatus comprising:

registrant detection means for detecting, by checking a captured image captured by an imaging apparatus mounted on a vehicle against face images of registrants, that the registrant has approached the vehicle, and detecting a position of the registrant;

control target determination means for determining which of a plurality of doors of the vehicle is to be controlled based on the position of the registrant;

inquiry means for asking the registrant whether or not to unlock a door lock; and

door control means for unlocking a lock of the door determined to be the control target based on a result of the inquiry.

### [Supplementary Note 2]

The unlocking apparatus according to Supplementary note 1, wherein the inquiry means acquires the result of the inquiry based on a voice or a movement of the registrant.

### [Supplementary Note 3]

The unlocking apparatus according to Supplementary note 1 or 2, wherein

the inquiry means acquires the result of the inquiry based on the movement of the registrant, and

the door control means unlocks the lock of the door when the movement of the registrant matches a predetermined pattern.

### [Supplementary Note 4]

The unlocking apparatus according to any one of Supplementary notes 1 to 3, wherein

the registrant detection means tracks the movement of the registrant when a distance between the registrant and the vehicle is within a first threshold value distance.

### [Supplementary Note 5]

The unlocking apparatus according to Supplementary note 4, wherein

the registrant detection means notifies the control target determination means of the position of the registrant when the distance between the registrant and the vehicle is within a second threshold value distance shorter than the first threshold value distance.

### [Supplementary Note 6]

The unlocking apparatus according to any one of Supplementary notes 1 to 5, wherein

after the door control means unlocks the lock of the door determined to be the control target, the inquiry means asks the registrant whether or not to open the door,

when the registrant instructs the door to be opened, the door control means opens the door determined to be the control target.

### [Supplementary Note 7]

The unlocking apparatus according to any one of Supplementary notes 1 to 6, further comprising:

user state detection means for detecting a state of the registrant, wherein

the door control means unlocks the door determined to be the control target and opens the door when the registrant has his or her hands full.

### [Supplementary Note 8]

The unlocking apparatus according to Supplementary note 6 or 7, wherein

the door control means checks whether or not there is a space for opening the door determined to be the control target, and opens the door when there is a space.

### [Supplementary Note 9]

The unlocking apparatus according to any one of Supplementary notes 1 to 8, wherein

when a person other than the registrant is present around the vehicle, the inquiry means asks the registrant whether or not to unlock the lock of the door corresponding to a position of the person other than the registrant, and

when the registrant instructs the door to be unlocked, the door control means unlocks the door according to the position of the person other than the registrant.

### [Supplementary Note 10]

A vehicle comprising:

an imaging apparatus configured to capture a periphery of the vehicle; and

an unlocking apparatus configured to unlock a door, wherein

the unlocking apparatus comprises:
registrant detection means for detecting, by checking a captured image captured by an imaging apparatus mounted on a vehicle against face images of registrants, that the registrant has approached the vehicle, and detecting a position of the registrant;
control target determination means for determining which of a plurality of doors of the vehicle is to be controlled based on the position of the registrant;
inquiry means for asking the registrant whether or not to unlock a door lock; and
door control means for unlocking a lock of the door determined to be the control target based on a result of the inquiry.

### [Supplementary Note 11]

The vehicle according to Supplementary note 10, wherein

the inquiry means acquires the result of the inquiry based on a voice or a movement of the registrant.

### [Supplementary Note 12]

The vehicle according to Supplementary note 10 or 11, wherein

the inquiry means acquires the result of the inquiry based on the movement of the registrant, and

the door control means unlocks the lock of the door when the movement of the registrant matches a predetermined pattern.

### [Supplementary Note 13]

An unlocking method comprising:

detecting, by checking a captured image captured by an imaging apparatus mounted on a vehicle against face images of registrants, that the registrant has approached the vehicle, and detecting a position of the registrant;

determining which of a plurality of doors of the vehicle is to be controlled based on the position of the registrant;

asking the registrant whether or not to unlock a door lock; and

unlocking a lock of the door determined to be the control target based on a result of the inquiry.

### [Supplementary Note 14]

A non-transitory computer readable medium storing a program for causing a processor to execute processing of:

detecting, by checking a captured image captured by an imaging apparatus mounted on a vehicle against face images of registrants, that the registrant has approached the vehicle, and detecting a position of the registrant;

determining which of a plurality of doors of the vehicle is to be controlled based on the position of the registrant;

asking the registrant whether or not to unlock a door lock; and

unlocking a lock of the door determined to be the control target based on a result of the inquiry.

### REFERENCE SIGNS LIST

10: UNLOCKING APPARATUS
11: REGISTRANT DETECTION MEANS
12: CONTROL TARGET DETERMINATION MEANS
13: INQUIRY MEANS
14: DOOR CONTROL MEANS
100: UNLOCKING APPARATUS
101: REGISTRANT DETECTION UNIT
102: CONTROL TARGET DETERMINATION UNIT
103: INQUIRY UNIT
104: DOOR CONTROL UNIT
105: USER STATE DETECTION UNIT
106: CHECKING IMAGE STORAGE UNIT

What is claimed is:

1. An unlocking apparatus comprising:
at least one memory storing instructions, and
at least one processor configured to execute the instructions to:
detect, by checking a captured image captured by an imaging apparatus mounted on a vehicle against face images of registrants, that the registrant has approached the vehicle, and detect a position of the registrant;
determine which of a plurality of doors of the vehicle is to be controlled based on the position of the registrant;
ask the registrant whether or not to unlock a door lock; and
unlock a lock of the door determined to be the control target based on a result of the inquiry.

2. The locking apparatus according to claim 1, wherein
the at least one processor is configured to execute the instructions to acquire the result of the inquiry based on a voice or a movement of the registrant.

3. The locking apparatus according to claim 1, wherein
the at least one processor is configured to execute the instructions to:
acquire the result of the inquiry based on the movement of the registrant, and
unlock the lock of the door when the movement of the registrant matches a predetermined pattern.

4. The locking apparatus according to claim 1, wherein
the at least one processor is configured to execute the instructions to track the movement of the registrant when a distance between the registrant and the vehicle is within a first threshold value distance.

5. The locking apparatus according to claim 4, wherein
the at least one processor is configured to execute the instructions to determine which of a plurality of doors of the vehicle is to be controlled when the distance between the registrant and the vehicle is within a second threshold value distance shorter than the first threshold value distance.

6. The locking apparatus according to claim 1, wherein
after the lock of the door determined to be the control, target is unlocked, the at least one processor is configured to execute the instructions to ask the registrant whether or not to open the door,
when the registrant instructs the door to be opened, the at least one processor is configured to execute the instructions to open the door determined to be the control target.

7. The locking apparatus according to claim 1, the at least one processor is further configured to execute the instructions to:
detect a state of the registrant, wherein
the at least one processor is configured to execute the instructions to unlock the door determined to be the control target and opens the door when the registrant has his or her hands full.

8. The locking apparatus according to claim 6, wherein
the at least one processor is configured to execute the instructions to check whether or not there is a space for opening the door determined to be the control target, and open the door when there is a space.

9. The locking apparatus according to claim 1, wherein
when a person other than the registrant is present around the vehicle, the at least one processor is configured to execute the instructions to ask the registrant whether or not to unlock the lock of the door corresponding to a position of the person other than the registrant, and
when the registrant instructs the door to be unlocked, the at least one processor is configured to execute the instructions to unlock the door according to the position of the person other than the registrant.

10. A vehicle comprising:
an imaging apparatus configured to capture a periphery of the vehicle; and
an unlocking apparatus configured to unlock a door, wherein
the unlocking apparatus comprises:
at least one memory storing instructions, and
at least one processor configured to execute the instructions to:
detect, by checking a captured image captured by an imaging apparatus mounted on a vehicle against face images of registrants, that the registrant has approached the vehicle, and detect a position of the registrant;
determine which of a plurality of doors of the vehicle is to be controlled based on the position of the registrant;
ask the registrant whether or not to unlock a door lock; and
unlock a lock of the door determined to be the control target based on a result of the inquiry.

11. The vehicle according to claim 10, wherein
the at least one processor is configured to execute the instructions to acquire the result of the inquiry based on a voice or a movement of the registrant.

12. The vehicle according to claim 10, wherein
the at least one processor is configured to execute the instructions to:
acquire the result of the inquiry based on the movement of the registrant, and
unlock the lock of the door when the movement of the registrant matches a predetermined pattern.

13. An unlocking method comprising:
detecting, by checking a captured image captured by an imaging apparatus mounted on a vehicle against face images of registrants, that the registrant has approached the vehicle, and detecting a position of the registrant;
determining which of a plurality of doors of the vehicle is to be controlled based on the position of the registrant;
asking the registrant whether or not to unlock a door lock; and
unlocking a lock of the door determined to be the control target based on a result of the inquiry.

14. (canceled)
